(19) United States
(12) Patent Application Publication
(10) Pub. No.: US 2014/0246898 A1
(43) Pub. Date: Sep. 4, 2014

(54) Hydraulically Actuated Regulating Valve for a Vehicle Brake System, and Associated Vehicle Brake System

(71) Applicant: Robert Bosch GmbH, Stuttgart (DE)

(72) Inventor: Dietmar Kratzer, Tamm (DE)

(73) Assignee: Robert Bosch GmbH, Stuttgart (DE)

(21) Appl. No.: 14/353,167

(22) PCT Filed: Oct. 4, 2012
(86) PCT No.: PCT/EP2012/069597

§ 371 Date: Apr. 21, 2014

(30) Foreign Application Priority Data
Nov. 8, 2011 (DE) 10 2011 085 881.4

(51) Int. Cl. B60T 11/34; B60T 13/68; G05D 16/16; F16K 31/122; G05D 16/10

(52) U.S. Cl. CPC B60T 11/34; F16K 31/1221; G05D 16/106; G05D 16/166; B60T 13/686
USPC 303/10; 137/505

(57) ABSTRACT

A hydraulically actuated regulating valve for a vehicle brake system includes a first fluid port, a second fluid port, and a control chamber. A longitudinally movable plunger with a sealing geometry is loaded with a spring force and held in an initial position by a compression spring. A pressure built up in the control chamber acts counter to the compression spring and moves the plunger with the sealing geometry from the initial position into an end position. The sealing geometry interacts with a valve seat which is positioned in a valve body in order to limit an effective pressure at the second fluid port to a predefined maximum pressure value. A fluid connection between the first and second fluid port is completely opened up to a corresponding vehicle brake system in a first end position of the plunger and is completely closed in a second end position of the plunger.

### PRIOR ART

The invention starts from a hydraulically actuated regulating valve for a vehicle brake system of the kind specified in independent patent claim 1 and from an associated vehicle brake system having at least one regulating valve of this kind.

German Offenlegungsschrift DE 10 2007 038 397 A1 describes a brake system for a vehicle. The brake system described comprises a fluid control unit having a spool valve, which is inserted into a suction line between a return pump and a brake master cylinder in order to limit the effective pressure on the suction side of the return pump to a predefinable maximum pressure value. The spool valve described is integrated directly into a bore in a fluid block and comprises two fluid ports and a pressure compensated port leading to the atmosphere, wherein a longitudinally movable piston on the pressure compensated side is loaded with a spring force by a compression spring arranged outside a fluid flow and, in an initial position, completely opens up the fluid connection between the two fluid ports via an internal bore and, in an end position, completely shuts off said connection.

German Offenlegungsschrift DE 10 2008 002 539 A1 describes a regulating valve for a vehicle brake system having a first fluid port, a second fluid port and a pressure compensated port leading to the atmosphere. The regulating valve described comprises a longitudinally movable control piston which, on the pressure compensated side, is loaded with a spring force by an actuating spring arranged outside the fluid flow and, in an initial position, completely opens up a fluid connection between the first fluid port and the second fluid port. The regulating valve furthermore comprises a valve body, which has a sealing seat, and a sealing element, which is coupled to the control piston by a pin that passes through the sealing seat, wherein a sealing region of the sealing element interacts with the sealing seat of the valve body in order to limit an effective pressure at the second fluid port to a predefinable maximum pressure value. Moreover, an effective diameter of the control piston is made greater than or equal to an effective diameter of the sealing element.

Offenlegungsschrift 10 2009 027 706 A1 describes a regulating valve for a vehicle brake system having a first fluid port, a second fluid port and a pressure compensated port leading to the atmosphere. The regulating valve described comprises a longitudinally movable control piston unit having a closing element which is loaded with a spring force in the region of the pressure compensated port by a compression spring arranged outside the fluid flow and, in an initial position, completely opens up a fluid connection between the first fluid port and the second fluid port. The closing element interacts with a valve seat in order to limit an effective pressure at the second fluid port to a predefinable maximum pressure value. The region of the pressure compensated port having the compression spring is furthermore arranged between the valve seat and a control chamber (19), said control chamber being connected to the second fluid port and being delimited by a control piston of the longitudinally movable control piston unit. In this case, the pressure built up in the control chamber acts against the spring force of the compression spring, and an effective diameter of the control piston is made greater than or equal to an effective diameter of the closing element.

### DISCLOSURE OF THE INVENTION

In contrast, the hydraulically actuated regulating valve according to the invention for a vehicle brake system having the features of independent patent claim 1 and the associated vehicle brake system have the advantage that the regulating valve has a simple valve construction consisting largely of sleeves and, when hydraulic pressure is applied, is moved counter to a spring force by virtue of differences in pressure surfaces. The difference in pressure surfaces can be implemented by means of a plunger which, either alone or in combination with at least one seal, forms on a first region an effective first diameter which, in combination with an applied pressure, assists a movement of the plunger in a first direction, and, on a second region, forms an effective second diameter, which is equal to or smaller than the first diameter and, in combination with an applied pressure, assists a movement of the plunger in a second direction, which is opposed to the first direction.

Embodiments of the present invention make available a hydraulically actuated regulating valve for a vehicle brake system which comprises a first fluid port and a second fluid port and a control chamber. In this case, a longitudinally movable plunger with a sealing geometry is loaded with a spring force and held in an initial position by a compression spring, wherein a pressure built up in the control chamber acts counter to the spring force of the compression spring and moves the plunger with the sealing geometry from the initial position into an end position, wherein the sealing geometry interacts with a valve seat which is arranged in a valve body in order to limit an effective pressure at the second fluid port to a predefinable maximum pressure value. In addition, a fluid connection between the first fluid port and the second fluid port is completely opened up in a first end position of the plunger and is completely shut off in a second end position of the plunger. According to the invention, the plunger is guided in a first sleeve, and the valve body and the first and second fluid ports are arranged in a second sleeve, which is connected in a fluidtight manner to the first sleeve. Moreover, in the region of the control chamber, the plunger forms an effective first diameter which, in conjunction with an applied pressure, assists a movement of the plunger in a first direction, and, in the region of the second sleeve, forms an effective second diameter, which is equal to or smaller than the first diameter and which, in conjunction with an applied pressure, assists a movement of the plunger in a second direction, which is opposed to the first direction.

Embodiments of the regulating valve according to the invention can be embodied either as normally open or as normally closed 2/2-way valves. In the case of a normally open embodiment, the longitudinally movable plunger is loaded with a spring force by the compression spring and held in an open initial position, in which the fluid connection between the first fluid port and the second fluid port is completely opened up. Moreover, a pressure built up in the control chamber acts counter to the spring force of the compression spring and moves the plunger with the sealing geometry in the direction of the valve seat as far as the closed end position, in which the fluid connection between the first fluid port and the second fluid port is completely shut off. In the case of a normally closed embodiment, the longitudinally movable plunger is loaded with a spring force by the compression spring and the sealing geometry is pressed into the valve seat, with the result that the fluid connection between the first fluid port and a second fluid port is completely shut off in this closed initial position. Moreover, a pressure built up in the control chamber acts against the spring force of the compression spring and moves the plunger, with the result that the sealing geometry rises from the valve seat and, in an open end position, completely opens up the fluid connection between the first fluid port and the second fluid port.

A vehicle brake system according to the invention comprises a brake master cylinder, a fluid control unit and at least one wheel brake, wherein, for brake pressure modulation of the at least one wheel brake in at least one brake circuit, the fluid control unit in each case has a switchover valve, an intake valve and a return pump. In this case, the intake valve is embodied as a hydraulically actuated regulating valve according to the invention, which is in each case inserted into a suction line between the corresponding return pump and the brake master cylinder.

Advantageous improvements of the hydraulically actuated regulating valve specified in independent patent claim 1 and intended for a vehicle brake system are possible by means of the measures and developments presented in the dependent claims.

It is particularly advantageous that the compression spring is surrounded by operating medium and is supported on the second sleeve. This is advantageously beneficial in avoiding spring corrosion. Moreover, the plunger is designed in such a way that it is arranged on one side relative to the valve seat or valve body and does not pass through the valve seat.

In an advantageous embodiment of the regulating valve according to the invention, the control pressure in the control chamber can be built up via at least one internal bore in the plunger or via a third fluid port, for example. The internal bore in the plunger advantageously allows simple routing of the fluid in the fluid block in which the regulating valve is installed. By virtue of the third fluid port, the plunger can be embodied without an internal bore and the effective diameters can easily be enlarged. Moreover, routing of the fluid within the regulating valve can be simplified.

In another advantageous embodiment of the regulating valve according to the invention, the compression spring can be supported on a collar, which is connected to the second sleeve or is formed on the second sleeve, for example. The collar can be embodied as an annular collar, for example, and can be arranged above an inlet opening in the second sleeve. As a result, the flow of the operating medium is advantageously unaffected by the compression spring. As an alternative, the compression spring can be supported directly on the valve body, which is connected to the second sleeve. It is thereby advantageously possible to reduce the overall height of the regulating valve.

In another advantageous embodiment of the regulating valve according to the invention, the control chamber can be sealed off with respect to the first sleeve by means of a first seal seated in a fixed manner on the plunger and can be closed off by a cover connected to the first sleeve. By means of the first seal seated in a fixed manner, the effective first sealing diameter for the hydraulic force with its closing action can be enlarged according to the embodiment of the first seal. The first seal can be embodied as a grooved ring or as a continuous sealing diaphragm, for example.

In another advantageous embodiment of the regulating valve according to the invention, the first sleeve can be embodied as a pot in one piece with the cover. It is thereby possible advantageously to reduce the number of parts required.

In another advantageous embodiment of the regulating valve according to the invention, a second seal is arranged in an axially fixed manner between a first support connected to the first sleeve and a support connected to the second sleeve, and provides a radial seal with respect to the plunger, which is pulled through under the second seal. The second seal can be embodied as a grooved ring or as a perforated sealing diaphragm, for example.

In another advantageous embodiment of the regulating valve according to the invention, the plunger can be of multipart design. It is thereby possible to implement the various functional diameters in a simple manner. Moreover, the multipart embodiment is a simple means of providing division(s) and joints in or at grooves introduced into the plunger for the seals or the abutment for the compression spring.

Illustrative embodiments of the invention are shown in the drawings and are explained in greater detail in the following description. In the drawings, the same reference signs denote components or elements which perform the same or similar functions.

### BRIEF DESCRIPTION OF THE DRAWINGS

FIG. 1 shows a schematic sectional representation of a first illustrative embodiment of a hydraulically actuated regulating valve according to the invention for a vehicle brake system.

FIG. 2 shows a schematic sectional representation of a second illustrative embodiment of a hydraulically actuated regulating valve according to the invention for a vehicle brake system.

FIG. 3 shows a schematic sectional representation of a third illustrative embodiment of a hydraulically actuated regulating valve according to the invention for a vehicle brake system.

FIG. 4 shows a schematic sectional representation of a fourth illustrative embodiment of a hydraulically actuated regulating valve according to the invention for a vehicle brake system.

FIG. 5 shows a schematic sectional representation of an illustrative embodiment a one-piece first sleeve, which additionally performs the function of a cap for the first and second illustrative embodiments of the hydraulically actuated regulating valve according to the invention for a vehicle brake system in FIGS. 1 and 2.

FIG. 6 shows a schematic sectional representation of another illustrative embodiment of a one-piece first sleeve, which additionally performs the function of a cap for the first and second illustrative embodiments of the hydraulically actuated regulating valve according to the invention for a vehicle brake system in FIGS. 1 and 2.

FIG. 7 shows a schematic sectional representation of another illustrative embodiment of a one-piece first sleeve, which additionally performs the function of a cap for the first and second illustrative embodiments of the hydraulically actuated regulating valve according to the invention for a vehicle brake system in FIGS. 1 and 2.

FIG. 8 shows a schematic plan view of the one-piece first sleeve from FIG. 7.

FIG. 9 shows a schematic sectional representation of an illustrative embodiment of a shortened plunger and of a compression spring, which is supported on a valve body connected to a second sleeve, for the first, second, third and fourth illustrative embodiments of the hydraulically actuated regulating valve according to the invention for a vehicle brake system in FIGS. 1 to 4.

FIG. 10 shows a schematic sectional representation of an illustrative embodiment of a multipart plunger for the third and fourth illustrative embodiments of the hydraulically actuated regulating valve according to the invention for a vehicle brake system in FIGS. 3 and 4.

### EMBODIMENTS OF THE INVENTION

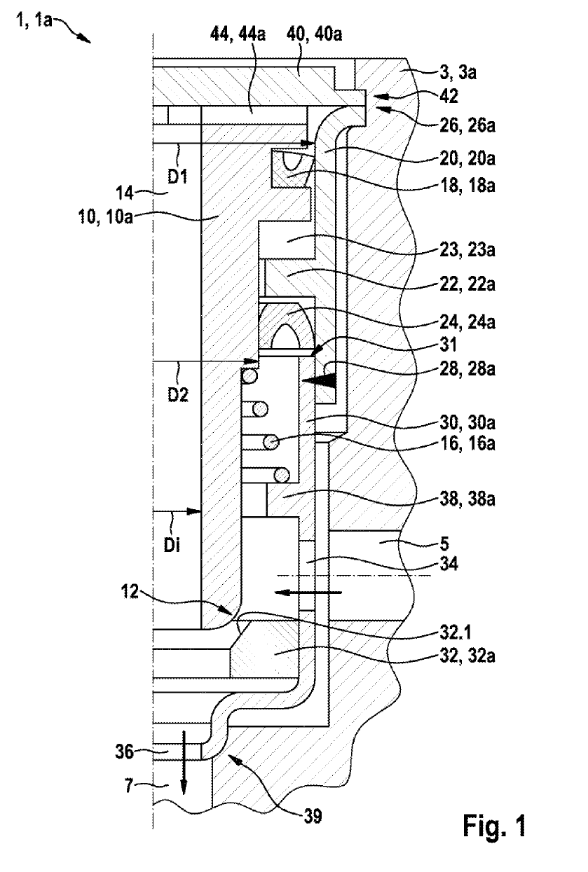

As can be seen from FIGS. 1 to 4, the illustrative embodiments shown of a hydraulically actuated regulating valve 1 according to the invention for a vehicle brake system comprise a first fluid port 34, which is connected to a brake master cylinder of the vehicle brake system by an inlet bore 5 in a fluid block or pump casing 3, 3a, for example, a second fluid port 36, which is connected to a fluid pump of the vehicle brake system by an outflow bore 7 in the fluid block or pump casing 3, 3a, for example, and a control chamber 44. In this arrangement, a longitudinally movable plunger 10 with a sealing geometry 12 is loaded with a spring force and held in an initial position by a compression spring 16, wherein a pressure built up in the control chamber 44 acts counter to the spring force of the compression spring 16 and moves the plunger 10 with the sealing geometry 12 from the initial position into an end position, wherein the sealing geometry 12 interacts with a valve seat 32.1 which is arranged in a valve body 32 in order to limit an effective pressure at the second fluid port 36 to a predefinable maximum pressure value. A fluid connection between the first fluid port 34 and the second fluid port 36 is completely opened up in a first end position of the plunger 10 and is completely shut off in a second end position of the plunger 10.

According to the invention, the plunger 10 is guided in a first sleeve 20, and the valve body 32 and the first and second fluid ports 34, 36 are arranged in a second sleeve 30, which is connected in a fluidtight manner to the first sleeve 20. In the region of the control chamber 44, the plunger 10 forms an effective first diameter D1 which, in conjunction with an applied pressure, assists a movement of the plunger 10 in a first direction, and, in the region of the second sleeve 30, forms an effective second diameter D2, which is equal to or smaller than the first diameter D1 and which, in conjunction with the applied pressure, assists a movement of the plunger 10 in a second direction, which is opposed to the first direction.

In the illustrative embodiments shown, a normally open regulating valve is illustrated in each case, and therefore the first end position of the plunger 10 corresponds to the open initial position illustrated and the second end position of the plunger 10 corresponds to a closed end position which is not shown. Moreover, the movement of the plunger 10 in the first direction corresponds to a closing movement and the movement of the plunger 10 in the second direction corresponds to an opening movement. In alternative illustrative embodiments, which are not shown, the hydraulically actuated regulating valve according to the invention for a vehicle brake system is embodied as a normally closed regulating valve, in which the first end position of the plunger corresponds to a closed initial position and the second end position of the plunger corresponds to an open end position. Moreover, the movement of the plunger in the first direction corresponds to an opening movement and the movement of the plunger in the second direction corresponds to a closing movement.

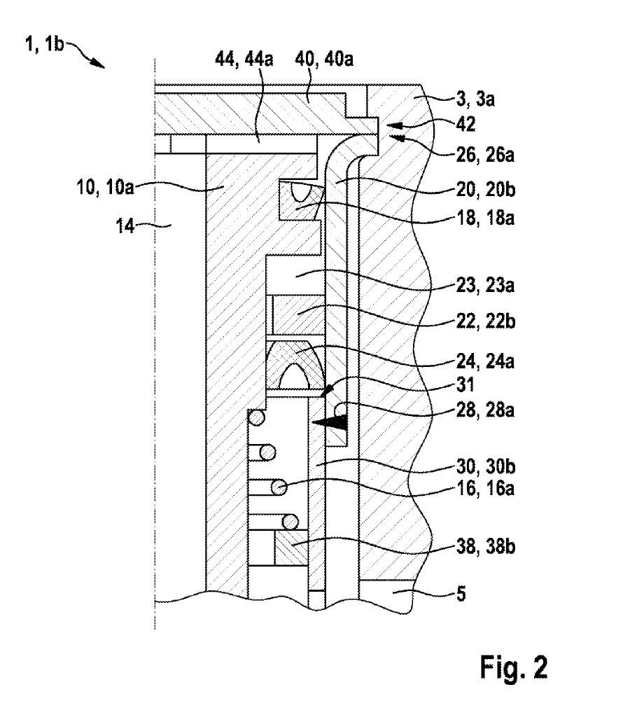

As can furthermore be seen from FIGS. 1 and 2, the valve body 32, 32a is pressed in a leaktight manner into the second sleeve 30, 30a, 30b, which is embodied as a valve sleeve, and carries the valve seat 32.1. At the bottom end, the plunger 10, 10a bears the sealing geometry 12, which is embodied as a spherical or conical segment, for example, and is provided with the internal bore 14, which is embodied as a concentric bore. As an alternative, a plurality of internal bores and/or eccentric internal bores can be provided and the plunger 10 can be provided on the end, for example, with grooves arranged in a star shape, for example, through which a hydraulic pressure is directed onto the end of the plunger 10 which is arranged in the control chamber 44, 44a. There, the hydraulic pressure is sealed off with respect to the first sleeve 20, 20a, 20b by a first seal 18, which is seated in a fixed manner on the plunger 10 and is embodied as a grooved ring 18a, for example. This means that the effective first diameter D1 is formed by an inside diameter of the first sleeve 20, 20a, 20b, wherein a diameter Di of the internal bore 14 in the plunger 10, 10a has to be taken into account. In the illustrative embodiment shown, the hydraulic pressure acting on the difference of the first diameter D1 and the diameter Di of the internal bore 14 assists the closing movement of the plunger 10, 10a. The control chamber 44, 44a and the entire regulating valve 1, la are closed off from the outside by a cap 40, 40a. In this arrangement, the cap 40, 40a is connected to the first sleeve 20, 20a, 20b by a first joint 26, 26a. At the same time, a caulking/staking geometry 42, by means of which the regulating valve 1, 1a, 1b is caulked or staked in a fluidtight manner in the fluid block or pump casing 3, 3a, is formed in this first joint region.

As can furthermore be seen from FIG. 1, a further seal 24, which is embodied as a grooved ring 24a for example, is seated in an axially fixed manner between a support ring 22, 22a and the valve sleeve 30, 30a in the first illustrative embodiment of the regulating valve 1, la according to the invention. In the first illustrative embodiment shown, the support ring 22, 22a is formed on the first sleeve 20, 20a and is of one-piece design with the latter. Moreover, the support 31 for the second seal 24, 24a on the valve sleeve 30, 30a corresponds to the upper rim of the valve sleeve 30, 30a. In an alternative embodiment which is not shown, an additional (support) ring can be provided for the second seal 24, 24a between the valve sleeve 30, 30a and the second seal 24, 24a. Radial support for the second seal 24, 24a is provided on the inside of the first sleeve 20, 20a, and the second seal 24, 24a provides a seal with respect to the plunger 10, 10a, which is pulled through under the second seal 24, 24a. This means that the effective second diameter D2 is defined by an inside diameter of the second seal 24, 24a, which is embodied as a grooved ring 24a, said inside diameter resting against the plunger 10, 10a. Here too, the diameter Di of the internal bore 14 in the plunger 10, 10a must be taken into account. In the illustrative embodiment shown, the hydraulic pressure acting on the difference between the second diameter D2 and the diameter Di of the internal bore 14 assists the opening movement of the plunger 10, 10a. A free space 23, 23a between the two seals 18, 24 is filled with air and can be used to receive leakage. As an alternative, the two seals 18, 24 on the pressure side and/or on the counterpressure side can be provided with support rings or similar additional components.

As can furthermore be seen from FIG. 1, the compression spring 16, 16a with its opening action engages on an offset on the plunger 10, 10a and is supported at the same time on a ring 38, 38a, which is formed on the valve sleeve 30, 30a and is of one-piece design with the latter. The compression spring 16, 16a is arranged outside the direct flow of the operating medium but is surrounded by said medium. Furthermore, the first sleeve 20, 20a and the valve sleeve 30, 30a are sealed off from one another and secured relative to one another, e.g. by a joint 28, 28a designed as an encircling laser weld. As an alternative, other suitable types of joint and combinations thereof, e.g. beading, caulking/staking, pressing etc., are also possible.

The inlet bore 5 and the outflow bore 7 in the fluid block or pump casing 3, 3a are separated by a press-fit joint 39 between an offset on the valve sleeve 30, 30a and the fluid block or pump casing 3, 3a.

As can furthermore be seen from FIG. 2, the further seal 24, which is embodied as a grooved ring 24a for example, is also seated in an axially fixed manner between a support ring 22, 22b and the valve sleeve 30, 30a in the second illustrative embodiment. However, in the second illustrative embodiment shown, the support ring 22, 22b is embodied as a separate part, which is press-fitted into the first sleeve 20, 20b at a defined position. Similarly to the first illustrative embodiment, the support 31 for the second seal 24, 24a on the valve sleeve 30, 30b corresponds to the upper rim of the valve sleeve 30, 30b. As in the first illustrative embodiment, radial support for the second seal 24, 24a is provided on the inside of the first sleeve 20, 20b, and the second seal 24, 24a provides a seal with respect to the plunger 10, 10a, which is pulled through under the second seal 24, 24a.

As can furthermore be seen from FIG. 2, the compression spring 16, 16a with its opening action engages on an offset on the plunger 10, 10a and is supported at the same time on a ring 38, 38b which, in contrast to the first illustrative embodiment, is embodied as a separate part that is press-fitted into the valve sleeve 30, 30b to implement a defined spring preload. As in the first illustrative embodiment, the compression spring 16, 16a is arranged outside the direct flow of the operating medium but is surrounded by said medium, and the first sleeve 20, 20b and the valve sleeve 30, 30b are sealed off from one another and secured relative to one another, e.g. by the joint 28, 28a designed as an encircling laser weld. As an alternative, other suitable types of joint and combinations thereof, e.g. beading, caulking/staking, pressing etc., are also possible here too.

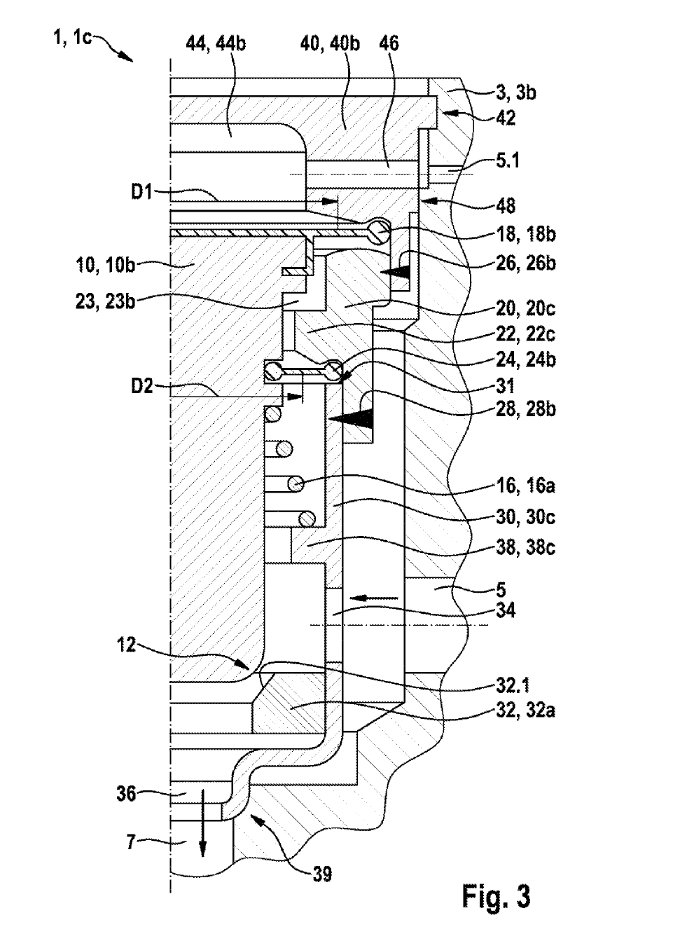

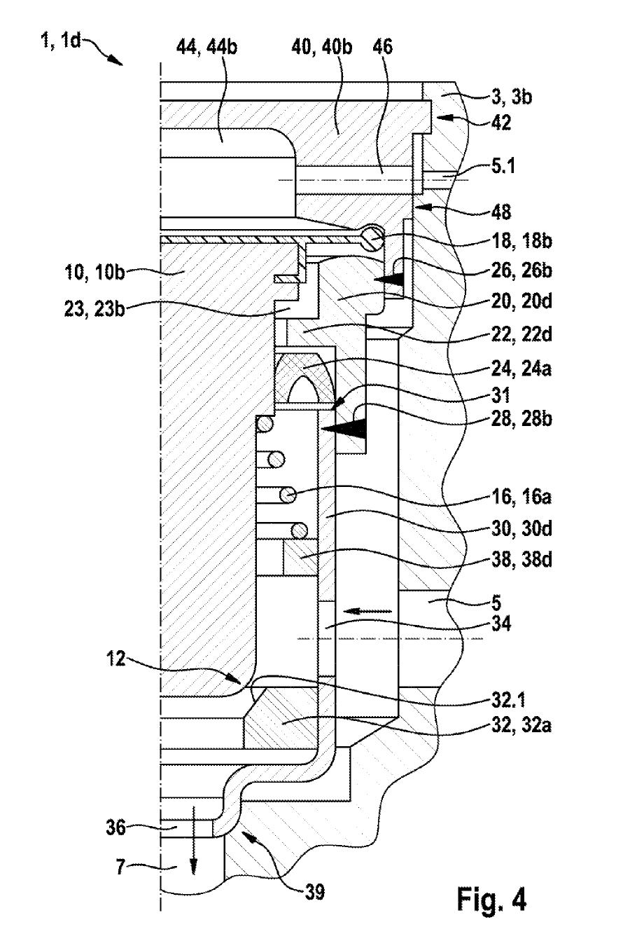

As can furthermore be seen from FIGS. 3 and 4, in the third and fourth illustrative embodiment too the valve body 32, 32a is press-fitted into the second sleeve 30, 30c, 30d, which is embodied as a valve sleeve, in a leaktight manner and bears the valve seat 32.1. In contrast to the first and second illustrative embodiments, the plunger 10, 10b of this pressure balanced control valve 1, 1c, 1d does not require an internal bore and is of solid design. For this reason, the control chamber 44, 44b is connected to the fluid pump by a third fluid port 46 and a corresponding bore 5.1 in the fluid block or pump casing 3, 3b. Similarly to the first and second illustrative embodiments, the plunger 10, 10b bears a sealing geometry 12, which is embodied as a spherical or conical segment for example, and is pressed into the open initial position by the compression spring 16, 16a. In this case, similarly to the first and second illustrative embodiments, the compression spring 16, 16a engages on an offset on the plunger 10, 10b and is supported relative to the housing on a ring 38, 38c, 38d, which is of one-piece design with the valve sleeve 30, 30c in the third illustrative embodiment shown in FIG. 3 and, as an alternative, is embodied as an extra part that is press-fitted into the sleeve 30, 30d to match the spring force in the fourth illustrative embodiment shown in FIG. 4. Similarly to the first and second illustrative embodiments, the compression spring 16, 16a is arranged outside the direct flow of the operating medium but is surrounded by the latter.

As can furthermore be seen from FIGS. 3 and 4, a first seal 18, 18b in the form of a diaphragm delimiting the control chamber 44, 44b is embodied in a continuous manner and therefore in a leak-free manner. The first seal 18, 18b is connected in a fixed manner to the end of the plunger 10, 10b by means of a suitable geometry, wherein the outside diameter of the first seal 18, 18a is seated and provides a seal in an annular groove which is formed by the first sleeve 20, 20c, 20d and the cap 40, 40b. In an alternative embodiment (not shown), this annular groove can be formed in just one component, i.e. either in the cap 40 or in the first sleeve 20. Similarly to the first and second illustrative embodiments, the cap 40, 40b closes off the regulating valve 1, 1c, 1d and makes available the geometry 42 for fixing the valve 1, 1c, 1d in the fluid block or pump casing 3, 3b. The regulating valve 1, 1c, 1d is preferably fixed in the fluid block or pump casing 3, 3a by means of a caulking/staking process. As an alternative, the fixing geometry can be made available by some other component, e.g. by the first sleeve 20, 20c, 20d.

As can furthermore be seen from FIGS. 3 and 4, the individual housing parts comprising the first sleeve 20, 20c, 20d, the valve sleeve 30, 30c, 20d and the cap 40, 40b are mounted, sealed off and fixed one inside the other. Thus, the first sleeve 20, 20c, 20d is connected to the cap 40, 40b, e.g. by an encircling first laser weld 26, 26b and to the valve sleeve 30, 30c, 30d by an encircling second laser weld 28, 28b. As an alternative, other suitable types of joint and combinations thereof, e.g. beading, caulking/staking, pressing etc., can also be used.

As can furthermore be seen from FIG. 3, the plunger 10, 10b is sealed off with respect to the first sleeve 20, 20c by a second seal 24, which is embodied as a perforated sealing diaphragm 24b. The second seal 24 embodied as a perforated sealing diaphragm 24b accommodates the stroke motion of the plunger by intrinsic deformation with as little loss of force or as little hysteresis as possible. The second seal 24 embodied as a perforated sealing diaphragm 24b is situated on the outside in an annular groove which is formed by the valve sleeve 30, 30c and the first sleeve 20, 20c. In an alternative embodiment (not shown), this annular groove can be formed in just one component, i.e. either in the valve sleeve 30 or in the first sleeve 20. The free space 23, 23b between the two seals 18, 18b and 24, 24b is filled with air and can be used to receive leakage.

The control chamber formed between the first seal 18, 18b and the cap 40, 40b is connected to the pump element pressure p(PE) by the third fluid port 46, wherein a first effective area of D1²⁺π/4 is obtained owing to the solid design of the plunger 10, 10b, said area having a closing effect with the pump element pressure p(PE). An inlet pressure p(Hz) is applied on the opposite side to the second seal 24, which is embodied as a perforated sealing diaphragm 24b, resulting in a second effective area of D2²⁺π/4 owing to the solid design of the plunger 10, 10b, said area having an opening effect with the inlet pressure p(Hz), wherein the second effective diameter D2 is less than the first effective diameter D1 and an average diameter of the diaphragm geometry is used by way of approximation in each case for calculation.

At the bottom, sealing between the inlet pressure p(Hz) or the inlet bore 5 and the pump element pressure p(PE) or bore 5.1 and/or the outflow bore 7 is accomplished by means of a press-fit joint 39 between an offset of the valve sleeve 30, 30c and the fluid block or pump casing 3, 3b and, at the top, sealing is accomplished by another press-fit joint 48 between the cap 20, 20b in the fluid block or pump casing 3, 3b.

As can furthermore be seen from FIG. 4, in contrast to the third illustrative embodiment, the second seal 24 in the fourth illustrative embodiment, similarly to the first and second illustrative embodiments, is embodied as a seal in the form of a grooved ring 24a or similar which slides on the plunger 10, 10b with as little loss of force or as little hysteresis as possible and is arranged in an axially fixed manner between a support ring 22, 22d and the valve sleeve 30, 30d. In the fourth illustrative embodiment shown, the solid embodiment of the plunger 10, 10b results in an effective second diameter D2 which corresponds to the inside diameter of the grooved ring 24a resting against the plunger 10, 10b. Similarly to the other illustrative embodiments, the support 31 for the second seal 24, 24a on the valve sleeve 30, 30d corresponds to the upper rim of the valve sleeve 30, 30d. Moreover, the supporting 22, 22d is of one-piece design with the first sleeve 20, 20d.

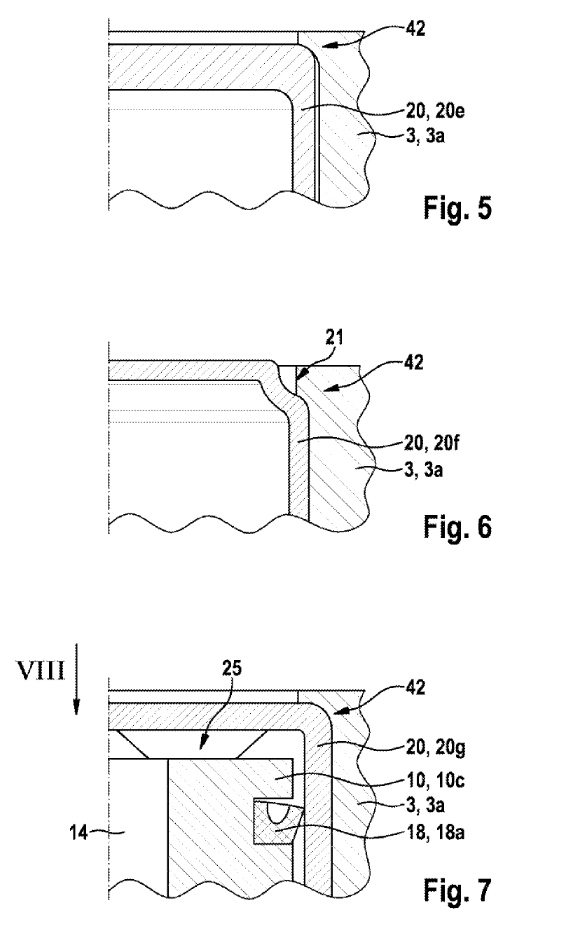

Various embodiments of the first sleeve 20, which simultaneously perform the function of the cap 40, are described below with reference to FIGS. 5 to 8.

As can be seen from FIGS. 5 to 8, the first sleeve 20, 20e, 20f, 20g has a base which is embodied in the form of a pot and which performs the function of the cap 40.

As can furthermore be seen from FIG. 5, the base of the sleeve 20, 20e is caulked or staked directly to the fluid block or pump casing 3, 3a in the illustrative embodiment shown to produce the caulking/staking 42.

As can furthermore be seen from FIG. 6, an offset 21 is formed on the base of the sleeve 20, 20f to optimize the caulking/staking 42. Thus, in the illustrative embodiment shown, the sleeve 20, 20f is caulked or staked to the fluid block or pump casing 3, 3a by means of the offset 21 to produce the caulking/staking.

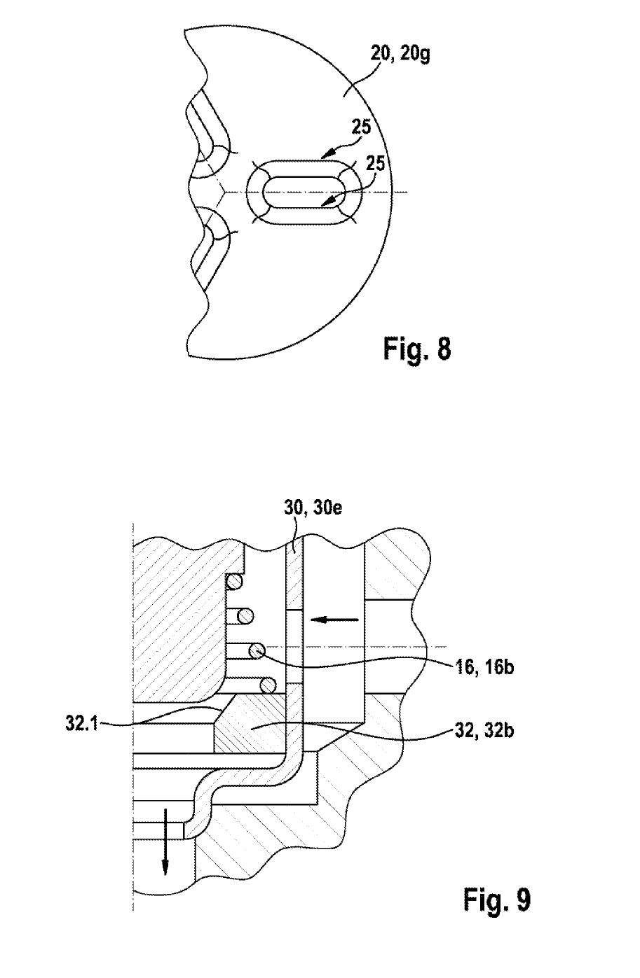

As can furthermore be seen from FIGS. 7 and 8, star shaped pressure outlet geometry on the end of the plunger 10, 10a can also be achieved by means of a plunger 10, 10c with a flat end and a first sleeve 20, 20g provided with projections and grooves. In the illustrative embodiment shown, a plurality of beads 25 is introduced into the base of the sleeve 20, 20g. In the illustrative embodiment shown, three beads 25 at an angle of about 120° to one another are preferably introduced into the base.

As can furthermore be seen from FIG. 9, the compression spring 16, 16b in the illustrative embodiment shown is supported directly on an end face of the valve body 32, 32b, which is press-fitted into the valve sleeve 30, 30e and bears the valve seat 32.1. This allows a shortened structural shape, wherein there is a flow of operating medium around the turns of the compression spring 16, 16b and therefore it is likely that the flow and the compression spring 16, 16b will influence one another.

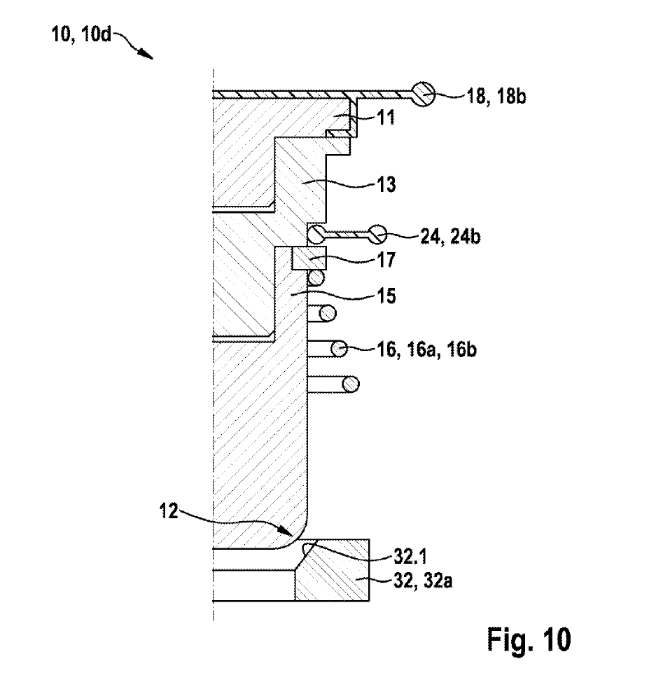

As can furthermore be seen from FIG. 10, it may be expedient, owing to the many functional diameters of the plunger 10, to construct the plunger 10c from several parts. Thus, for example, division(s) and joints can be provided in or at the grooves for the first seal 18, which is embodied as a sealing diaphragm 18b, and/or for the second seal 24, which is embodied as a perforated sealing diaphragm 24b, and/or on the offset formed as an abutment for the compression spring 16, 16a, 16b. A first part 11 forms an upper end of the plunger and part of a groove for the first seal 18, which is embodied as a sealing diaphragm 18b, for example. A second part 13 forms a central part of the plunger and, for example, holds the first seal 18, which is embodied as a sealing diaphragm 18b and forms part of the groove for the second seal 24, which is embodied as a perforated sealing diaphragm 24b. To connect the first part 11 to the second part, the first part 11 can be press-fitted into the second part 13. An abutment ring 17 can form the abutment for the compression spring 16, 16a, 16b and part of the groove to receive the second seal 24, which is embodied as a perforated sealing diaphragm 24b, for example. A third part 15 forms a lower end of the plunger and, for example, guides the compression spring 16, 16a, 16b and comprises the sealing geometry 12. To connect the second part 13 to the third part 15, the second part 13 can be press-fitted into the third part 15.

1. A hydraulically actuated regulating valve for a vehicle brake system, having:
a first fluid port;
a second fluid port;
a control chamber; and
a compression spring configured to load a longitudinally movable plunger having a sealing geometry with a spring force and hold the longitudinally movable plunger in an initial position;
wherein the control chamber is configured such that a pressure buildup in the control chamber acts counter to the spring force of the compression spring and moves the longitudinally movable plunger with the sealing geometry from the initial position into an end position;
wherein the sealing geometry is configured to interact with a valve seat which is positioned in a valve body in order to limit an effective pressure at the second fluid port to a predefined maximum pressure value;
wherein a fluid connection between the first fluid port and the second fluid port is completely opened up in a first end position of the longitudinally movable plunger and is completely shut off in a second end position of the longitudinally movable plunger;
wherein a first sleeve is configured to guide the longitudinally movable plunger, and the valve body and the first and second fluid ports are positioned in a second sleeve, which is connected in a fluidtight manner to the first sleeve; and
wherein, in a region of the control chamber, the longitudinally movable plunger forms an effective first diameter which, in conjunction with an applied pressure, is configured to assist a movement of the plunger in a first direction, and, in a region of the second sleeve, forms an effective second diameter, which is equal to or smaller than the first diameter and which, in conjunction with an applied pressure, is configured to assist a movement of the plunger in a second direction, which is opposed to the first direction.

2. The regulating valve as claimed in claim 1, wherein the compression spring is surrounded by operating medium and is supported on the second sleeve.

3. The regulating valve as claimed in claim 1, wherein either at least one internal bore in the longitudinally movable plunger or via a third fluid port is configured to buildup pressure in the control chamber.

4. The regulating valve as claimed in claim 2, wherein the compression spring;
is supported on a collar, which is connected to the second sleeve;
is formed on the second sleeve; or
is supported on the valve body, which is connected to the second sleeve.

5. The regulating valve as claimed in claim 1, wherein the control chamber is sealed off with respect to the first sleeve via a first seal seated in a fixed manner on the longitudinally movable plunger and is closed off by a cover connected to the first sleeve.

6. The regulating valve as claimed in claim 5, wherein the first sleeve is configured to form a single piece with the cover and is defined by a substantially pot-like shape.

7. The regulating valve as claimed in claim 1, wherein a second seal is positioned in an axially fixed manner between a first support connected to the first sleeve and a second support connected to the second sleeve, and is configured to provide a radial seal with respect to the longitudinally movable plunger, which is configured to be pulled through under the second seal.

8. The regulating valve as claimed in claim 5, wherein at least one of:
the first seal includes a first grooved ring or a continuous sealing diaphragm; and
the second seal includes a second grooved ring or a perforated sealing diaphragm.

9. The regulating valve as claimed in claim 1, wherein the longitudinally movable plunger is a multipart plunger.

10. A vehicle brake system having:
a brake master cylinder;
a fluid control unit; and
at least one wheel brake;
wherein, for brake pressure modulation of the at least one wheel brake in at least one brake circuit, the fluid control unit has a respective switchover valve, a respective intake valve and a respective return pump corresponding to each of the at least one wheel brake;
wherein the respective intake valve is a regulating valve, is inserted into a respective suction line between the corresponding respective return pump and the brake master cylinder, and includes:
a first fluid port;
a second fluid port;
a control chamber; and
a compression spring configured to load a longitudinally movable plunger having a sealing geometry with a spring force and hold the longitudinally movable plunger in an initial position;
wherein the control chamber is configured such that a pressure buildup in the control chamber acts counter to the spring force of the compression spring and moves the longitudinally movable plunger with the sealing geometry from the initial position into an end position;
wherein the sealing geometry is configured to interact with a valve seat which is positioned in a valve body in order to limit an effective pressure at the second fluid port to a predefined maximum pressure value;
wherein a fluid connection between the first fluid port and the second fluid port is completely opened up in a first end position of the longitudinally movable plunger and is completely shut off in a second end position of the longitudinally movable plunger;
wherein a first sleeve is configured to guide the longitudinally movable plunger, and the valve body and the first and second fluid ports are positioned in a second sleeve, which is connected in a fluidtight manner to the first sleeve; and
wherein, in a region of the control chamber, the longitudinally movable plunger forms an effective first diameter which, in conjunction with an applied pressure, is configured to assist a movement of the plunger in a first direction, and, in a region of the second sleeve, forms an effective second diameter, which is equal to or smaller than the first diameter and which, in conjunction with an applied pressure, is configured to assist a movement of the plunger in a second direction, which is opposed to the first direction.
